(19) United States
(12) Patent Application Publication
(10) Pub. No.: US 2014/0278147 A1
(43) Pub. Date: Sep. 18, 2014

(54) CRYSTALLINE PHASE IDENTIFICATION METHOD, CRYSTALLINE PHASE IDENTIFICATION DEVICE, AND CRYSTALLINE PHASE IDENTIFICATION PROGRAM

(71) Applicant: Rigaku Corporation, Tokyo (JP)

(72) Inventors: Akito SASAKI, Tokyo (JP); Akihiro HIMEDA, Tokyo (JP)

(73) Assignee: Rigaku Corporation, Tokyo (JP)

(21) Appl. No.: 14/209,033

(22) Filed: Mar. 13, 2014

(30) Foreign Application Priority Data
Mar. 14, 2013 (JP) 2013-052338

(51) Int. Cl. G01N 23/207

(52) U.S. Cl. CPC G01N 23/207
USPC 702/28

(57) ABSTRACT

A crystalline phase identification method, a crystalline phase identification device, and a crystalline phase identification program which can conduct qualitative analysis with higher precision are provided. The crystalline phase identification method for identifying crystalline phases contained in a sample by powder diffraction pattern of the sample with use of database includes: a whole pattern fitting step of subjecting a first diffraction pattern which is the powder diffraction pattern to whole pattern fitting with the use of crystalline phase information contained in the sample to calculate a theoretical diffraction pattern of the crystalline phase(s) already identified; a residual information generating step of generating residual information on the sample on the basis of a difference between the theoretical diffraction pattern and the first diffraction pattern; and a residual information search and matching step of comparing the residual information with the database to select a new crystalline phase contained in the sample.

### CROSS-REFERENCE TO RELATED APPLICATION

The present application claims priority from Japanese application JP 2013-052338 filed on Mar. 14, 2013, the content of which is hereby incorporated by reference into this application.

### BACKGROUND OF THE INVENTION

1. Field of the Invention

The present invention relates to a crystalline phase identification method, a crystalline phase identification device, and a crystalline phase identification program for identifying a crystalline phase included in a sample on the basis of a powder diffraction pattern of the sample.

2. Description of the Related Art

A powder diffraction pattern of a power sample is obtained by, for example, measurement using an x-ray diffraction device. A powder diffraction pattern of a certain crystalline phase is specific to the crystalline phase. In the present specification, a material means a pure material, and the crystalline phase is represented as both a chemical composition of the material and a crystal structure of the material where the material should be a crystalline material. When a sample consists of a mixture of plural crystalline phase, a powder diffraction pattern of the sample is obtained by adding respective powder diffraction patterns of the plural crystalline phases contained in the sample together on the basis of contents thereof.

A qualitative analysis identifies the crystalline phase contained in the sample by the powder diffraction pattern generated by measurement data of an x-ray diffraction measurement. Information on powder x-ray diffraction patterns of crystalline phases as candidates are registered in a database. The database is, for example, a PDF (powder diffraction file) of the ICDD (international centre for diffraction data), and information on peak positions d of the powder diffraction pattern of the crystalline phase and integrated intensities I of the peaks are included in information registered in the PDF. About 250,000 cards of crystalline phases are registered in the database of the ICDD if the crystalline phase is an inorganic crystalline phase. In general, in the qualitative analysis, the crystalline phases are identified as follows. First, a powder diffraction pattern of a sample is generated according to x-ray diffraction data of the sample measured by an x-ray diffraction measurement. The powder diffraction pattern of the sample is compared with the information on the peak positions and the peak intensities of a plurality of crystalline phases stored in such a database, and a crystalline phase that matches the peak positions and peak intensities of the powder diffraction pattern of the sample is searched from the plurality of crystalline phases stored in the database, and the matched crystalline phase is set as a candidate of the crystalline phase contained in the sample. The identification method of the crystalline phase in the related art is disclosed in, for example, JP H0843327 A and JP H1164251 A. In the present specification, a technique in which a powder diffraction pattern of a sample or measurement information extracted from the powder diffraction pattern is compared with the information on the plurality of crystalline phases stored in the database, and the crystalline phase that matches the powder diffraction pattern of the sample or the measurement information extracted from the powder diffraction pattern of the sample is searched from the database to identify the crystalline phase contained in the sample is called “search and matching”. As the identification method of the crystalline phase, there have been known a Hanawalt technique, a Johnson/Vand technique, and a SANDMAN (search and match on nova) as well as a profile based search. The profile based search is a method in which a shape of the pattern is emphasized and identified.

### SUMMARY OF THE INVENTION

A method of conducting qualitative analysis of a sample with the use of a powder diffraction pattern of the sample with higher precision is desired. Through the use of a fact that a powder diffraction pattern of a mixture is obtained by summing powder diffraction patterns of respective crystalline phases, the present inventors have studied a crystalline phase identification method using the following. First, peak positions d and integrated intensities I are calculated according to the powder diffraction pattern of the sample to generate a list (d-I list) of the peak positions d of the sample and the integrated intensities I (Step 1). The d-I list of the sample is compared with d-I lists of a plurality of crystalline phases stored in a database to identify the most matching crystalline phase as one crystalline phase contained in the sample (Step 2). The integrated intensities I of the crystalline phase is normalized with the use of, for example, a first highest intensity line (the integrated intensity I having the highest peak in the integrated intensities I) of the d-I list of the crystalline phase stored in the database, and the normalized integrated intensities I of the crystalline phase in question is subtracted from the d-I list of the sample to generate a corrected d-I list (Step 3). Steps 2 and 3 are executed on the corrected d-I list, and the execution is repeated until a given condition is satisfied. In the above analysis method, normally, the crystalline phase contained in the sample is identified from the crystalline phase in descending order of an ingredient amount one by one. In Step 3, the integrated intensities I of the crystalline phase is normalized with the use of the first highest intensity line. On the other hand, if the normalization using the first highest intensity line is not successful, normalization may be conducted with the use of a second or third highest intensity line.

The powder diffraction pattern of the sample is obtained by the x-ray diffraction measurement of the sample. For that reason, the powder diffraction pattern of the sample includes an error caused by a measurement device or measurement environments. Also, since the powder diffraction pattern of the sample is superposition of the plurality of peaks each having a finite width, two peaks having the peak positions d close to each other may be recognized as one peak in error, and the misrecognition of the peak position d causes a precision in the identification of the crystalline phase to be lowered. Also, when the d-I list of the sample is compared with the d-I lists registered in the database to identify crystalline phases contained in the sample, there is a need to allow the error in a wide range for matching the peak position d. In the above crystalline phase identification method studied by the present inventors, every time the integrated intensities I of the identified crystalline phase is subtracted from the d-I list (or the corrected d-I list) of the sample, the error contained in the corrected d-I list is relatively increased to make the search and matching based on the corrected d-I list difficult. For that reason, in the above crystalline phase identification method, the crystalline phase having a relatively large ingredient amount contained in the sample can be identified, but the crystalline phase having a slight ingredient amount is difficult to identify.

The present invention has been made in view of the above problem, and therefore an object of the present invention is to provide a crystalline phase identification method, a crystalline phase identification device, and a crystalline phase identification program which can conduct a qualitative analysis with higher precision.

(1) In order to solve the above problem, according to the present invention, there is provided a crystalline phase identification method for identifying crystalline phases contained in a sample by a powder diffraction pattern of the sample with use of a database storing at least information on peak positions and peak intensities of a plurality of crystalline phases, the method including: a whole pattern fitting step of subjecting a first diffraction pattern which is the powder diffraction pattern of the sample to whole pattern fitting with use of crystalline phase information contained in the sample which is information on the crystalline phase(s) already identified to calculate a theoretical diffraction pattern of the crystalline phase(s) already identified; a residual information generating step of generating residual information on the sample on basis of a difference between the theoretical diffraction pattern of the crystalline phase(s) already identified which is calculated in the whole pattern fitting step, and the first diffraction pattern; and a residual information search and matching step of comparing the residual information generated in the residual information generating step with the peak positions and the peak intensities of the plurality of crystalline phases stored in the database to select a new crystalline phase contained in the sample from the plurality of crystalline phases stored in the database.

(2) The crystalline phase identification method according to the above item (1) may further include a search and matching step, which is executed before the whole pattern fitting step, of comparing the powder diffraction pattern of the sample with the peak positions and the peak intensities of the plurality of crystalline phases stored in the database to select a crystalline phase contained in the sample from the plurality of crystalline phases stored in the database, and set the selected crystalline phase as the crystalline phase information contained in the sample.

(3) The crystalline phase identification method according to the above item (1) or (2) may further include a search and matching result determining step of determining whether further identification is conducted, or not, on basis of a matching degree of identification in the residual information search and matching step, and if the further identification is conducted, adding information on the new crystalline phase selected in the residual information search and matching step to the crystalline phase information contained in the sample, and further subjecting the first diffraction pattern which is the powder diffraction pattern of the sample to the whole pattern fitting step, the residual information generating step, and the residual information search and matching step, with use of the crystalline phase information contained in the sample.

(4) The crystalline phase identification method according to the above item (1) or (2) may further include a search and matching result determining step of determining whether further identification is conducted, or not, on basis of a matching degree of identification in the residual information search and matching step, and if the further identification is conducted, newly setting information on the new crystalline phase selected in the residual information search and matching step as the crystalline phase information contained in the sample, newly setting a residual diffraction pattern obtained by subtracting the theoretical diffraction pattern of the crystalline phase(s) already identified from the first diffraction pattern as the first diffraction pattern, and further subjecting the first diffraction pattern to the whole pattern fitting step, the residual information generating step, and the residual information search and matching step, with use of the crystalline phase information contained in the sample.

(5) According to the present invention, there is provided a crystalline phase identification device for identifying crystalline phases contained in a sample by a powder diffraction pattern of the sample with use of a database storing information on peak positions and peak intensities of a plurality of crystalline phases, the device including: a whole pattern fitting unit that subjects a first diffraction pattern which is the powder diffraction pattern of the sample to whole pattern fitting with use of crystalline phase information contained in the sample which is information on the crystalline phase(s) already identified to calculate a theoretical diffraction pattern of the crystalline phase(s) already identified; a residual information generating unit that generates residual information on the sample on basis of a difference between the theoretical diffraction pattern of the crystalline phase(s) already identified which is calculated in the whole pattern fitting unit, and the first diffraction pattern; and a residual information search and matching unit that compares the residual information generated in the residual information generating unit with the peak positions and the peak intensities of the plurality of crystalline phases stored in the database to select a new crystalline phase contained in the sample from the plurality of crystalline phases stored in the database.

(6) According to the present invention, there is provided a crystalline phase identification program for identifying crystalline phases contained in a sample by a powder diffraction pattern of the sample with use of a database storing information on peak positions and peak intensities of a plurality of crystalline phases, the crystalline phase identification program causing a computer to function as: a whole pattern fitting unit that subjects a first diffraction pattern which is the powder diffraction pattern of the sample to whole pattern fitting with use of crystalline phase information contained in the sample which is information on the crystalline phase(s) already identified to calculate a theoretical diffraction pattern of the crystalline phase(s) already identified; a residual information generating unit that generates residual information on the sample on basis of a difference between the theoretical diffraction pattern of the crystalline phase(s) already identified which is calculated in the whole pattern fitting unit, and the first diffraction pattern; and a residual information search and matching unit that compares the residual information generated in the residual information generating unit with the peak positions and the peak intensities of the plurality of crystalline phases stored in the database to select a new crystalline phase contained in the sample from the plurality of crystalline phases stored in the database.

According to the present invention, there are provided a crystalline phase identification method, a crystalline phase identification device, and a crystalline phase identification program which can conduct the qualitative analysis with higher precision.

### BRIEF DESCRIPTION OF THE DRAWINGS

FIG. 1 is a block diagram illustrating a configuration of a crystalline phase identification device according to an embodiment of the present invention;

FIG. 2 is a flowchart illustrating a crystalline phase identification method according to the embodiment of the present invention;

FIG. 3 is a flowchart illustrating a search and matching step in the crystalline phase identification method according to the embodiment of the present invention;

FIG. 4 is a flowchart illustrating a whole pattern fitting step in the crystalline phase identification method according to the embodiment of the present invention;

FIG. 5A is a diagram illustrating a spectrum of a diffraction pattern in the crystalline phase identification method according to the embodiment of the present invention;

FIG. 5B is a diagram illustrating a spectrum of a diffraction pattern in the crystalline phase identification method according to the embodiment of the present invention;

FIG. 5C is a diagram illustrating a spectrum of a diffraction pattern in the crystalline phase identification method according to the embodiment of the present invention;

FIG. 5D is a diagram illustrating a spectrum of a diffraction pattern in the crystalline phase identification method according to the embodiment of the present invention; and

FIG. 5E is a diagram illustrating a spectrum of a diffraction pattern in the crystalline phase identification method according to the embodiment of the present invention.

### DETAILED DESCRIPTION OF THE INVENTION

### First Embodiment

Hereinafter, a crystalline phase identification method according to a first embodiment of the present invention will be described specifically and in detail with the accompanying drawings. The crystalline phase identification method according to this embodiment is automatically executed by a crystalline phase identification device 1 according to this embodiment. That is, the crystalline phase identification device 1 according to this embodiment can automatically conduct qualitative analysis of a sample with the use of the crystalline phase identification method according to this embodiment. FIG. 1 is a block diagram illustrating a configuration of the crystalline phase identification device 1 according to this embodiment. The crystalline phase identification device 1 according to this embodiment includes an analysis unit 2, an information input unit 3, an information output unit 4, and a storage unit 5. The crystalline phase identification device 1 is realized by a computer generally used. The crystalline phase identification device 1 is connected to an x-ray diffraction device 11. The x-ray diffraction device 11 measures x-ray diffraction data of the sample through x-ray diffraction measurement for a powder sample, and outputs the measured x-ray diffraction data to the information input unit 3 of the crystalline phase identification device 1. The analysis unit 2 acquires the x-ray diffraction data from the information input unit 3, and subjects the x-ray diffraction data to preprocessing to generate a powder diffraction pattern of the sample. In the present specification, the preprocessing represents smoothing, background subtraction, and Kα₂ subtraction. The powder diffraction pattern generated by the analysis unit 2 is input to the storage unit 5, and held therein. The x-ray diffraction device 11 may include an analysis unit (data processing unit), subject the x-ray diffraction data measured by the analysis unit of the x-ray diffraction device 11 to preprocessing to generate the powder diffraction pattern of the sample, and output the powder diffraction pattern of the sample to the information input unit 3 of the crystalline phase identification device 1. Also, the preprocessing is not always necessary, and the measured x-ray diffraction data may be set as the powder diffraction pattern of the sample. In this case, the analysis unit 2 acquires the measured x-ray diffraction data from the information input unit 3, and allows the x-ray diffraction data to be held in the storage unit 5 as the powder diffraction pattern of the sample. The analysis unit 2 acquires the powder diffraction pattern of the sample from the storage unit 5 (or the information input unit 3), automatically identifies the crystalline phase contained in the sample on the basis of the powder diffraction pattern, and outputs the identified crystalline phase to the information output unit 4 together with its content (weight fraction) as an analysis result. The information output unit 4 outputs the information on the crystalline phase to a display device 12 to be connected, and displays the analysis result on the display device 12. The analysis unit 2 of the crystalline phase identification device 1 includes respective units for executing steps described below. Also, a crystalline phase identification program according to this embodiment causes a computer to function as the respective units.

FIG. 2 is a flowchart illustrating the crystalline phase identification method according to the embodiment of the present invention. FIG. 3 is a flowchart illustrating a search and matching step (Step 2) in the crystalline phase identification method according to the embodiment, and FIG. 4 is a flowchart illustrating a whole pattern fitting step (Step 3) in the crystalline phase identification method according to the embodiment. Also, FIGS. 5A to 5E are diagrams each illustrating a spectrum of a diffraction pattern in the crystalline phase identification method according to the embodiment.

### [Step 1: Powder Diffraction Pattern Acquiring Step]

In Step 1, the powder diffraction pattern of the sample is acquired. The powder diffraction pattern of the sample is held in the storage unit 5. Alternatively, as described above, the x-ray diffraction device 11 may include the analysis unit (data processing unit), and subjects the x-ray diffraction data of the sample to be measured to preprocessing to generate the powder diffraction pattern of the sample, and output the powder diffraction pattern of the sample to the information input unit 3 of the crystalline phase identification device 1. Also, when the preprocessing is not required, the x-ray diffraction device 11 may output the x-ray diffraction data of the sample to be measured to the information input unit 3 as the powder diffraction pattern of the sample. The analysis unit 2 of the crystalline phase identification device 1 acquires the powder diffraction pattern of the sample from the storage unit 5 (or the information input unit 3). FIG. 5A illustrates the spectrum of the powder diffraction pattern of the sample, in which the axis of abscissa represents 2θ indicative of the peak position, and the axis of ordinate is an intensity of the spectrum. Respective peak Numbers (1 to 30) are attached to a plurality of peaks contained in the powder diffraction pattern of the sample. The x-ray diffraction data of the sample measured by the x-ray diffraction device 11 may be input to the information input unit 3, or held in the storage unit 5. In this case, the analysis unit 2 acquires the x-ray diffraction data of the sample from the information input unit 3 or the storage unit 5, subjects the x-ray diffraction data of the sample to preprocessing, and generates the powder diffraction pattern of the sample. Also, when the preprocessing is not required, the analysis unit 2 acquires the x-ray diffraction data of the sample as the powder diffraction pattern of the sample from the information input unit 3 or the storage unit 5.

### [Step 2: Search and Matching Step]

In Step 2, the powder diffraction pattern of the sample is subjected to search and matching with the use of the database storing at least information on the peak positions and the peak intensities of the plurality of crystalline phases therein. That is, the powder diffraction pattern of the sample is compared with the peak positions and the peak intensities of the plurality of crystalline phases stored in the database to select crystalline phase(s) contained in the sample from the plurality of crystalline phases stored in the database, and the selected crystalline phase(s) is/are set as crystalline phase information contained in the sample. In this example, the crystalline phase information contained in the sample is information of the crystalline phase(s) already identified, and the crystalline phase(s) already identified (crystalline phase name or code of the crystalline phase) is stored therein. Hereinafter, the search and matching will be described with reference to FIG. 3.

(a) The respective peak positions d and integrated intensities I of the plurality of peaks are calculated according to the spectrum of the powder diffraction pattern of the sample, and the calculated peak positions d and integrated intensities I are listed to create a d-I list of the sample (data listing step). In this step, each peak of the powder diffraction pattern of the sample is subjected to profile fitting, and the peak positions d and the integrated intensities I are calculated according to an approximate peak profile thereof. The reason that the profile fitting is conducted for each of the peaks is because a shape of an independent peak may be different depending on the crystalline phase, or the plurality of peaks may be superposed on each other to form an asymmetric shape, and it is not proper that the peak shapes approximate one kind of peak shape parameter. If the profile fitting is conducted with one kind of peak shape parameter, it is conceivable that an impermissible error maybe included in the peak positions d and the integrated intensities I calculated by the approximate peak profile.

FIG. 5B schematically illustrates the d-I list of the sample. In FIG. 5B, the axis of abscissa represents 2θ indicative of the peak positions like FIG. 5A, but the axis of ordinate represents the integrated intensities I of the peaks unlike FIG. 5A. FIG. 5B visually illustrates the integrated intensities I of the respective peaks with lengths of solid lines indicated at the peak positions of the respective peaks. In this embodiment, the peak intensity is an integrated intensity obtained by integrating the overall intensity of one peak. However, the present invention is not limited to this configuration, but, for example, the peak intensity may be a peak height at the peak position.

(b) A list (d-I list) of the peak positions d and the integrated intensities I in the plurality of crystalline phases is stored in the database. It is determined whether the respective three highest intensity lines of the plurality of crystalline phases stored in the database are included at the plurality of peak positions in the d-I list of the sample, or not. In the present specification, n (for example, n=3) highest intensity lines represent n peaks selected in descending order of the integrated intensities of the peaks. For a plurality of crystalline phases which are selected since the three highest intensity lines thereof in the d-I lists of the database are included in the d-I list of the sample, how the respective eight highest intensity lines of those crystalline phases match the plurality of peaks in the d-I list of the sample is quantified with the use of a FOM (figure of merit) on the basis of empirical formulas. In this example, the empirical formulas are different depending on whether the matching of the peak position d is emphasized, or the matching of the pattern having the integrated intensity I is emphasized, and a balance of the degree of importance can be arbitrarily set. The FOM quantifies how the d-I list of the crystalline phase stored in the database matches the d-I list of the sample, and the degree of matching is higher (the degree of coincidence is higher) as the quantified value is smaller. In the plurality of crystalline phases determined that the three highest intensity lines are included in the d-I list of the sample, the crystalline phase considered that eight highest intensity lines most match the d-I list of the sample, that is, the crystalline phase having the minimum FOM is determined as a first candidate of the crystalline phase contained in the sample (one-crystalline phase identifying step). In this example, the respective three highest intensity lines of the plurality of crystalline phases stored in the database are first compared with the d-I list of the sample, and the eight highest intensity lines are then compared with the d-I list of the sample to identify one of the crystalline phases contained in the sample. However, the number n (n=3, 8) of the n highest intensity lines used for comparison is consistently exemplary, and the present invention is not limited to this configuration. Also, the technique in which the crystalline phase contained in the sample is identified from the d-I list of the sample with the use of the database storing the d-I list of the plurality of crystalline phases therein may use the other known methods. This can be applied to all of search and matching described in the present specification.

(c) It is determined whether the processing proceeds to Step 3 or completes the crystalline phase identification method, according to the value of the FOM of the crystalline phase of the first candidate (identification result determining step). If the FOM of the crystalline phase in question is equal to or higher than a threshold value, the crystalline phase identification method is completed assuming that the crystalline phase that satisfies the degree of given matching could not be identified at all. In this case, an error message indicating that the crystalline phase could not be identified in the crystalline phase identification method is output to the information output unit 4. On the contrary, if the FOM of the crystalline phase in question is lower than the threshold value, the crystalline phase in question is selected as the crystalline phase contained in the sample, and Step (c), that is, Step 2 is completed with the crystalline phase in question as the crystalline phase information contained in the sample, and the processing proceeds to Step 3. In this example, the information on the crystalline phase included in the crystalline phase information contained in the sample is only one crystalline phase (crystalline phase name or code of the crystalline phase) identified in Step (b). In FIG. 3, a dashed arrow is indicated, which will be described later. In this embodiment, processing related to the dashed arrow is not conducted.

In this embodiment, if the value of the FOM in the crystalline phase of the first candidate is lower than the threshold value in Step (c), the flow proceeds to Step 3 under any circumstances, which is desirable from the viewpoint of the precision of the crystalline phase identification method. However, when it is apparent that information other than the identified one crystalline phase is not included in the d-I list of the sample, the crystalline phase identification method may be completed in Step (c) from the viewpoint of an improvement in calculation speed. In order to conduct the above determination, the following processing is conducted. First, a value obtained by multiplying the d-I list of the crystalline phase in question stored in the database by a coefficient corresponding to the content (the integrated intensity I of the crystalline phase in question in the powder diffraction pattern of the sample) is subtracted from the d-I list of the sample to create a corrected d-I list of the sample. In this example, the coefficient corresponding to the content is determined so that none of the eight highest intensity lines of the crystalline phase in question becomes a negative value in the corrected d-I list of the sample. Then, if a residual determination value calculated from the integrated intensity I in the corrected d-I list of the sample is lower than a set value, no other crystalline phase contained therein is present, or the content is as small as ignorable. Further, it is determined that there is no need to identify the crystalline phase, and the crystalline phase identification method is completed. In this case, the crystalline phase identified in Step (b) is set as the crystalline phase included in the sample, and the crystalline phase(s) in question (crystalline phase name or code of the crystalline phase), and its content (weight ratio) are output to the information output unit 4, and the crystalline phase and the content are displayed as an analysis result on the display device 12. In this example, the content of the crystalline phase becomes a value close to 100%.

### [Step 3: Whole Pattern Fitting Step]

In Step 3, a first diffraction pattern is subjected to whole pattern fitting by whole pattern analysis with the use of the crystalline phase information contained in the sample which the information on the crystalline phase(s) already identified to calculate the theoretical diffraction pattern of the crystalline phase(s) in the crystalline phase information contained in the sample. In this embodiment, the first diffraction pattern is the powder diffraction pattern of the sample.

In this example, the whole pattern fitting step (WPF: whole pattern fitting) represents an analysis method for fitting the diffraction pattern calculated according to profile parameters, lattice constants, parameters of preferred orientation into the powder diffraction pattern of the sample through the non-linear least-squares method. Because the individual peak profile is not fitted, but the overall powder diffraction pattern is fitted, the profile parameters depend on the peak position d. Also, the peak position d is constrained by the lattice constants. An analysis method including crystal structure parameters in the parameters for calculating the theoretical diffraction pattern in the whole pattern analysis is particularly called “Rietveld method”. As the whole pattern analyses, the Pawley method and the Le Bail method have been also known. In general, in the Rietveld method, the integrated intensity ratio of the respective peaks is constrained by the crystal structure parameters so that the crystal structure can be refined. In the whole pattern fitting according to this embodiment, the crystal structure parameters are fixed, and the refinement is not conducted. Hereinafter, Step 3 will be described below with reference to FIG. 4 with the Rietveld method as an example. In the present specification, the overall pattern fitting is not limited to a configuration in which the pattern is fitted into the powder diffraction pattern of the sample in an overall measurement range of the x-ray diffraction data of the sample to be measured. In the powder diffraction pattern of the sample which is obtained by the x-ray diffraction data of the sample to be measured, the pattern fitting into the powder diffraction pattern of the sample in a major measurement range is also included in the whole pattern fitting step. In the present specification, the major measurement range may be a measurement range including the peaks of the integrated intensities I which are equal to or higher than a given intensity to the degree sufficient to conduct the qualitative analysis, within the powder diffraction pattern of the sample. That is, in the present specification, the whole pattern fitting also includes the profile fitting to be conducted on the diffraction pattern of the sample in a desired measurement range including most of the major peaks.

(A) For use in the analysis through the Rietveld method, the first diffraction pattern, and one or a plurality of crystalline phases used for the analysis are set (fitting initializing step). In this embodiment, the first diffraction pattern is the powder diffraction pattern of the sample. The one or the plurality of crystalline phases used for analysis are all of the crystalline phases in the crystalline phase information contained in the sample, that is, all of the crystalline phases identified by the previous search and matching. In a first Step 3, the crystalline phases in the crystalline phase information contained in the sample are only one crystalline phase selected in Step 2 (search and matching step), and the one crystalline phase is a crystalline phase already identified.

(B) Through the Rietveld method, in the one or the plurality of crystalline phases used for analysis, the first diffraction pattern is subjected to the non-linear least-squares fitting on the basis of information on the lattice constants or the crystal structure parameters. In this situation, the profile parameters expressing the peak shapes, the lattice constants and peak shift parameters for determining the peak positions, and a global temperature factor are refined, but the parameters of preferred orientation and the crystal structure parameters which affect the peak intensities are fixed, and the refinement is not conducted. The fitting is conducted through the Rietveld method so that the diffraction patterns calculated according to all of the one or the plurality of crystalline phases used for analysis approximate the powder diffraction pattern of the sample, and the respective parameters are refined. That is, the respective parameters are optimized by analysis using the Rietveld method, and in this situation, the respective contents of the one or the plurality of crystalline phases used for analysis are also optimized for calculation. The diffraction patterns in the one or the plurality of crystalline phases which are calculated according to the respective optimized parameters are the theoretical diffraction patterns of the crystalline phase already identified (fitting executing step).

When the crystal structure parameters of the crystalline phase used for analysis is unknown (or absent), the integrated intensity ratio (diffraction pattern) of the respective peaks is replaced with the d-I list stored in the database. In this case, a precision in the fitting is degraded by this replacement, but the sufficiently useful information is obtained by the step in question with this precision.

R_{wp} is obtained as a value indicative of the reliability (likelihood) of least squares fitting for the whole pattern fitting conducted in the fitting executing step. In general, the results of the fitting are better as R_{wp} is smaller. It is desirable that a value indicating which of two analysis results is better uses a fitting determination value S which is a ratio of R_{wp} to the minimum value (Rₑ) of the theoretical R_{wp}. This indicates that the better analysis can be conducted as the value of the fitting determination value S is closer to 1.

(C) If the fitting determination value S is equal to or higher than a threshold value, Step 3 is completed, and the processing proceeds to Step 4. Also, if the fitting determination value S is lower than the threshold value, the crystalline phase(s) (crystalline phase name or code of the crystalline phase) included in the crystalline phase information contained in the sample, and the content obtained by the previous search and matching are output to the information output unit 4 as the identified crystalline phase and its content to complete the crystalline phase identification method (fitting result determining step). In this embodiment, the fitting result determining step is executed after the fitting executing step. However, the fitting result determining step is not essential, and Step 4 may be executed after the fitting executing step has been executed, without the provision of this determination criterion.

### [Step 4: Residual Information Generating Step]

In Step 4, residual information of the sample is generated on the basis of a difference between the theoretical diffraction pattern of “the crystalline phase(s) already identified” calculated in Step 3 (whole pattern fitting step), and the first diffraction pattern. In this embodiment, the theoretical diffraction pattern is subtracted from the first diffraction pattern to create a residual diffraction pattern. Then, a d-I list of the residual diffraction pattern is created in the same step as the data listing step (Step (a)) of Step 2 (search and matching step). The d-I list is included in the residual information of the sample.

FIG. 5C illustrates the theoretical diffraction pattern using the Rietveld method together with peak numbers at an upper stage, and the residual diffraction pattern at a lower stage. The residual diffraction pattern illustrated at the lower stage of FIG. 5C is refined, and the residual diffraction pattern is data having a precision sufficient to further conduct the search and matching. In the residual diffraction pattern, the respective peaks having the peak numbers of 2, 6, 8, 11, 14, 16, 20, and 21 are remarkably expressed. FIG. 5D is an enlarged diagram illustrating a neighborhood of the peaks having peak numbers 10 and 11 among the peaks illustrated in FIG. 5C. An upper stage of FIG. 5D further illustrates the powder diffraction pattern (dashed line) of the sample, and the d-I list of the sample, for facilitating understanding, in addition to the theoretical diffraction pattern (solid line). As illustrated at the upper stage of FIG. 5D, the powder diffraction pattern of the sample includes the peaks of peak numbers 10 and 11. On the contrary, the theoretical diffraction pattern includes the peak of peak number 10, but does not include the peak of peak number 11. The lower stage of FIG. 5D illustrates the residual diffraction pattern, and the residual diffraction pattern includes the peak of peak number 11, but does not include the peak of peak number 10.

### [Step 5: Residual Information Determining Step]

In Step 5, it is determined whether the residual information is subjected to the search and matching, or not, according to the information included in the residual information generated in Step (residual information generating step). First, a residual determination value indicative of whether information sufficient to conduct the search and matching is further included in the d-I list of the residual diffraction pattern, or not, is calculated according to the d-I list of the residual diffraction pattern. If the residual determining value is lower than a set value, it is determined that the information sufficient to conduct the search and matching is not further included in the d-I list of the residual diffraction pattern. The crystalline phase(s) (crystalline phase name or code of the crystalline phase) in the crystalline phase information contained in the sample used in the latest Step 3 (whole pattern fitting step), and the contents of the respective crystalline phases obtained by the whole pattern fitting in Step 3 are output to the information output unit 4 as the identified crystalline phases and the contents thereof, and the crystalline phase identification method is completed. On the contrary, if the residual determination value is equal to or higher than the set value, Step 5 is completed, and the processing proceeds to Step 6.

### [Step 6: Residual Information Search and Matching Step]

In Step 6, the d-I list of the residual diffraction pattern included in the residual information generated in Step 4 (residual information generating step) is compared with the peak positions and the peak intensities of the plurality of crystalline phases stored in the database to select a new crystalline phase contained in the sample from the plurality of crystalline phases stored in the database.

A technique of the search and matching which is conducted in Step 6 is identical with Step (b) (one-crystalline phase identifying step) in Step 2 (search and matching step) except that objects to be subjected to the search and matching are different from each other. The object to be subjected to the search and matching is the d-I list of the sample in Step (b) whereas the object is the d-I list of the residual diffraction pattern generated in Step 4 (residual information generating step). The crystalline phase which is the minimum FOM is selected from the d-I list of the residual diffraction pattern as a first candidate of a new crystalline phase contained in the sample.

### [Step 7: Search and Matching Result Determining Step]

In Step 7, it is determined whether further identification is conducted, or not, on the basis of the matching degree of identification in Step 6 (residual information search and matching step). If the further identification is conducted, the new crystalline phase selected in Step 6 is added to the crystalline phase information contained in the sample to newly generate the crystalline phase information contained in the sample. Steps 3, 4, 5, and 6 are further executed on the first diffraction pattern which is the powder diffraction pattern of the sample, with the use of the crystalline phase information contained in the sample newly generated. If the further identification is not conducted, the crystalline phase identification method is completed.

The determination of whether the further identification is conducted, or not, is similar to the identification result determining step (Step (c)) in Step 2 (search and matching step). Specifically, if the FOM of the crystalline phase newly selected in Step 6 is equal to or higher than the threshold value, the crystalline phase that satisfies a given degree of matching cannot be newly identified in Step 6, and it is determined that the crystalline phase selected in Step 6 is not contained in the sample. The crystalline phase(s) (crystalline phase name or code of the crystalline phase) in the crystalline phase information contained in the sample used in the latest Step 3 (whole pattern fitting step), and the contents of the respective crystalline phases obtained by the whole pattern fitting in Step 3 are output to the information output unit 4 as the identified crystalline phase(s) and the content(s) thereof, and the crystalline phase identification method is completed. If the FOM of the crystalline phase selected in the first Step 6 is equal to or higher than the threshold value, the crystalline phase already identified is only the crystalline phase selected in Step 2 (search and matching step). If the FOM of the crystalline phase selected in an n-th (n is an integer of n≧2) Step 6 is equal to or higher than the threshold value, the crystalline phases already identified are the crystalline phase selected in Step 2, and the crystalline phase selected in the first to (n−1)-th Step 6.

On the contrary, if the FOM of the crystalline phase in question is lower than the threshold value, the crystalline phase in question is added to the crystalline phase information contained in the sample to newly generate the crystalline phase information contained in the sample, and Step 3 is again executed. In Step 3, the first diffraction pattern (the powder diffraction pattern of the sample) is subjected to the whole pattern fitting with the use of the crystalline phase information contained in the sample newly generated. Thereafter, if it is determined that the residual information is subjected to the search and matching in Step 5 through Steps 4 and 5, Step 6 is further executed. In Step 7, it is again determined whether the further identification is conducted, or not, on the basis of the degree of identification in Step 6. Steps 3, 4, 5, and 6 are repetitively executed so far as it is determined that the further identification is conducted in Step 7.

The crystalline phase information contained in the sample used in the n-th (n is an integer of n≧2) Step 3 is n crystalline phases in total including one crystalline phase selected in Step 2, and (n−1) crystalline phase(s) selected in the first to (n−1)-th Steps 6 (residual information search and matching). The n crystalline phases have been already identified.

An upper stage of FIG. 5E illustrates a theoretical diffraction pattern which is the analysis result in the second Step 3, and a lower stage of FIG. 5E illustrates the residual diffraction pattern generated in the second Step 4. The residual diffraction pattern illustrated at the lower stage of FIG. 5E is remarkably reduced in the intensity of the integrated intensities I of the illustrated peaks as compared with the residual diffraction pattern illustrated at the lower stage of FIG. 5C. In the residual diffraction pattern illustrated at the lower stage of FIG. 5E, no information sufficient to further conduct the search and matching remains, and the residual determination value calculated in the second Step 5 is lower than the set value. Hence, in the second Step 5, two crystalline phases selected in Step 2 and the first Step 5, and the contents thereof are output to the information output unit 4, and the crystalline phase identification method is completed.

The crystalline phase identification method, the crystalline phase identification device, and the crystalline phase identification program according to this embodiment have been described above. The major features of the present invention are described below. In the first Step 3 (whole pattern fitting step), the powder diffraction patterns of the sample are subjected to the whole pattern fitting with the use of the crystalline phases already identified in Step 2 (search and matching) to calculate the theoretical diffraction pattern of the crystalline phase in question. Then, in the first Step 4 (residual information generating step), the residual information of the sample is generated on the basis of the difference between the powder diffraction pattern of the sample and the theoretical diffraction pattern. Further, in the first Step 6 (residual information search and matching), the residual information of the sample is subjected to the search and matching to identify a new crystalline phase.

The crystalline phase identification method according to the present invention will be compared with the above-mentioned crystalline phase identification method (hereinafter called “related crystalline phase identification method”) studied by the present inventors. In the related crystalline phase identification method, when one crystalline phase contained in the sample is identified, the integrated intensity I of the crystalline phase in question multiplied by a coefficient corresponding to the content is subtracted from the d-I list of the sample to generate the corrected d-I list, and the corrected d-I list is subjected to the identification of the new crystalline phase. On the contrary, in the crystalline phase identification method according to the present invention, the residual information of the sample is subjected to the search and the matching from the powder diffraction pattern of the sample and the theoretical diffraction pattern of the identified crystalline phase in question to identify the new crystalline phase. The residual information of the sample is based on the theoretical diffraction pattern refined by the whole pattern fitting, and more refined as compared with the related crystalline phase identification method, and the search and matching (residual information search and matching) in high reliability can be conducted.

For example, the powder diffraction pattern of the sample illustrated in FIG. 5D includes the two peaks of peak numbers 10 and 11, and it is conceivable that even if those peaks may be recognized as one peak, or recognized as two peaks in the d-I list of the sample, the values of the peak positions and the integrated intensities become larger in error than the actual values. For that reason, in the related crystalline phase identification method, when the integrated intensity I of the identified crystalline phase is subtracted from the d-I list of the sample to generate the corrected d-I list, if those peaks are recognized as one peak, the integrated intensity I of the identified crystalline phase is subtracted to generate the corrected d-I list as one peak. Also, even if those peaks are recognized as two peaks, the corrected d-I list is generated with the more residual error. When the above corrected d-I list is subjected to the search and matching, the erroneous crystalline phase may be selected as the new crystalline phase. Even if the correct crystalline phase is selected, the FOM of the crystalline phase in question becomes higher (the degree of matching is lower), and the reliability is degraded. On the contrary, in the crystalline phase identification method according to the present invention, the residual information of the sample is generated on the basis of the powder diffraction pattern of the sample illustrated in FIG. 5A, and the theoretical diffraction pattern illustrated at the upper stage of FIG. 5C. As described above, the peak of peak number 10 is included in the theoretical diffraction pattern illustrated at the upper stage of FIG. 5D, but is not included in the residual diffraction pattern illustrated at the lower stage of FIG. 5D. On the contrary, the peak of peak number 11 is not included in the theoretical diffraction pattern, but is included in the residual diffraction pattern. In the related crystalline phase identification method, those peaks may be recognized as one peak, or an impermissible error may be included even if those peaks are recognized as two peaks. On the contrary, in the crystalline phase identification method according to the present invention, the two peaks can be separated by conducting the whole pattern fitting. The residual information (the d-I list of the residual diffraction pattern) of the sample is more refined to enable the search and matching with higher reliability.

In particular, in this embodiment, one crystalline phase contained in the sample is selected in Step 2 (search and matching), and the powder diffraction pattern of the sample is subjected to the whole pattern fitting with the use of the selected crystalline phase in the first Step 3. One new crystalline phase is selected from the residual information (Step 4) obtained from the fitting results (Step 6). Further, in the second Step 3, the powder diffraction pattern of the sample is subjected to the whole pattern fitting with the use of the two crystalline phases thus selected, and one new crystalline phase is selected from the residual information obtained by the fitting result, and those selections are repetitively executed. In this way, the residual information is subjected to the search and matching to select one new crystalline phase. One crystalline phase thus selected is added, and the powder diffraction pattern of the sample is repetitively subjected to the whole pattern fitting as a result of which the residual information is more refined, and the search and matching in high reliability can be conducted.

In the crystalline phase identification method according to this embodiment, Step 5 (residual information determining step) is executed. With the provision of Step 5, if the information sufficient to further conduct the search and matching is not included in the residual information, the crystalline phase identification method can be terminated without further conducting the search and matching in Step 6. Therefore, it is desirable to execute Step 5 from the viewpoint of an improvement in calculation speed. However, Step 5 is not always required. When Step 5 is not executed, even if the residual determination value calculated from the d-I list of the residual diffraction pattern is lower than the set value, Step 6 is executed. In this case, it is conceivable that the FOM of the crystalline phase of a first candidate selected in Step 6 (residual information search and matching step) becomes a value equal to or higher than the threshold value, and the crystalline phase identification method is completed in subsequent Step 7 (search and matching result determining step).

Also, the residual information created in Step 4 (residual information generating step) in the crystalline phase identification method according to this embodiment is the d-I list of the residual diffraction pattern which is obtained by executing the same step as Step (a) (data listing step) of Step 2 (search and matching step) on the residual diffraction pattern. However, the present invention is not limited to this configuration. In Step 4, a profile for each peak may be added to the theoretical diffraction pattern of the crystalline phase already identified, and subjected to the profile fitting so as to approximate the first diffraction pattern (powder diffraction pattern of the sample) to create the d-I list.

Also, in this embodiment, the d-I list is created from the spectrum of the diffraction pattern, and subjected to the search and matching as compared with the d-I list of the plurality of crystalline phases stored in the database. However, the present invention is not limited to this configuration. For example, the powder diffraction patterns of the plurality of crystalline phases may be stored in the database, and the diffraction pattern may be subjected to the search and matching directly as compared with the database.

### Second Embodiment

A crystalline phase identification method according to a second embodiment of the present invention is identical with the crystalline phase identification method according to the first embodiment except that Step 2 (search and matching step) is different from each other. In the crystalline phase identification method according to the first embodiment, in Step 2, one crystalline phase contained in the sample is selected. On the other hand, in the crystalline phase identification method according to this embodiment, a plurality of crystalline phases contained in the sample can be selected. Hereinafter, Step 2 according to this embodiment will be described with reference to FIG. 3.

As in the first embodiment, in Step 2, the d-I list of the sample is created from the powder diffraction pattern of the sample by Step (a) (data listing step), and the crystalline phase which becomes the minimum FOM is determined as the crystalline phase contained in the sample by Step (b) (one-=crystalline phase identifying step). Unlike the first embodiment, in this embodiment, in Step (c) (identification result determining step), it is determined whether the crystalline phase is further identified, the processing proceeds to Step 3, or the crystalline phase identification method is completed, according to the value of the FOM of the crystalline phase determined in Step (b). If it is determined that the crystalline phase is further identified, one-crystalline-phase determining step is executed, and the crystalline phase contained in the sample is newly determined. This processing is repeated so far as Step (c) determines the further identification of the crystalline phase.

In Step (b), the d-I list to be searched is called “target d-I list”. In the first Step (b), the target d-I list is the d-I list of the sample as in the first embodiment.

In the first Step (c), as in Step (c) of the first embodiment, if the FOM of the crystalline phase determined in Step (b) is equal to or higher than the threshold value, the crystalline phase identification method is completed assuming that the crystalline phase satisfying a given degree of matching cannot be identified at all. If the FOM of the crystalline phase in question is lower than the threshold value, the crystalline phase of a first candidate is set as a first crystalline phase contained in the sample, and a value (the integrated intensities I of the crystalline phase in the powder diffraction pattern of the sample) obtained by multiplying the d-I list of the crystalline phase stored in the database by a coefficient corresponding to the content is subtracted from the d-I list of the sample to create a corrected d-I list of the sample. Unlike Step (c) in the first embodiment, the second step (b) is executed. In FIG. 3, a case in which the processing again proceeds to Step (b) from Step (c) is indicated by a dashed line as “further search”.

In the n-th (n is an integer of n≧2) Step (b), the target d-I list to be searched is the corrected d-I list of the sample created in the (n−1)-th Step (c). The crystalline phase (the crystalline phase having the minimum FOM) conceivable to most match the target d-I list is determined according to the crystalline phases stored in the d-I list of the database.

In the n-th Step (c), if the FOM of the crystalline phase determined in the n-th Step (b) is equal to or higher than the threshold value, information on all of the crystalline phase(s) identified till the (n−1)-th step (b) with no inclusion of the crystalline phase determined in the n-th Step (b) is set as the crystalline phase information contained in the sample, Step 2 is completed, and the processing proceeds to Step 3. The information on the crystalline phases included in the crystalline phase information contained in the sample is (n−1) crystalline phase(s) (crystalline phase name or the code of the crystalline phase). If the FOM of the crystalline phase in question is lower than the threshold value, the following processing is conducted. First, a value (integrated intensity I of the crystalline phase in the powder diffraction pattern of the sample) obtained by multiplying the d-I list of the crystalline phase stored in the database by a coefficient corresponding to the content is subtracted from the target d-I list in the n-th Step (b) to newly create a corrected d-I list of the sample. Then, a (n+1)-th step (b) is executed, and this processing is repeated so far as the FOM of the crystalline phase determined in Step (b) is lower than the threshold value.

In the crystalline phase identification method according to the first embodiment, one crystalline phase contained in the sample is selected in Step 2 (search and matching step), and the processing proceeds to Step 3. On the other hand, in the crystalline phase identification method according to this embodiment, one or a plurality of crystalline phases contained in the sample is selected in Step 2, and the processing proceeds to Step 3. So far as the FOM of the crystalline phase determined as a candidate of the crystalline phase contained in the sample is lower than the threshold value, the candidate is selected as the crystalline phase contained in the sample, thereby being capable of conducting the qualitative analysis at a higher speed. When (it is proved in advance that) a plurality of crystalline phases relatively large in the content is contained in the sample, the crystalline phase identification method according to this embodiment has remarkable advantages. In this embodiment, the threshold value of the FOM of the crystalline phase in Step 2 (search and matching step) is set as a first threshold value, and the threshold value of the FOM of the crystalline phase in Step 7 (search and matching result determining step) is set as a second threshold value, which may be different from each other. When the first threshold value is set to be higher than the second threshold value, the crystalline phase relatively large in the content can be identified in Step 2. Thereafter, with the use of the theoretical diffraction pattern refined in Step 3, the crystalline phase small in the content can be identified with higher precision in Step 6.

In this embodiment, if a value of the FOM of the crystalline phase of the first candidate is lower than the threshold value in Step (c), Step (b) is again executed under any circumstances. However, the present invention is not limited to this configuration. If a residual determination value calculated from the integrated intensity I in the corrected d-I list of the sample newly created in Step (c) is lower than the set value, it is determined there is no need to further identify the crystalline phase, and the crystalline phase identification method may be completed. In this case, the one or the plurality of crystalline phases identified in Step 2 is set as the crystalline phases contained in the sample, and the crystalline phase(s) in question (crystalline phase name or code of the crystalline phase) and the contents thereof are output to the information output unit 4.

### Third Embodiment

A crystalline phase identification method according to a third embodiment of the present invention is identical with the crystalline phase identification method according to the first or second embodiment except that the crystalline phase information contained in the sample generated in Step 7 (search and matching result determining step) and the first diffraction pattern are different from each other, and resultantly the first diffraction pattern and the crystalline phase information contained in the sample in Step 3 (whole pattern fitting step) to be next executed are different from each other. That is, it is determined whether the further identification is conducted, or not, on the basis of the matching degree of identification in Step 7. If the further identification is conducted, the information on the new crystalline phase selected in Step 6 (residual information search and matching step) is newly set as the crystalline phase information contained in the sample, and a residual diffraction pattern obtained by subtracting the theoretical diffraction pattern of the crystalline phase already identified from the first diffraction pattern is newly set as the first diffraction pattern. Steps 3, 4, 5, and 6 are further executed on the first diffraction pattern in question with the use of the crystalline phase information contained in the sample. Hereinafter, the crystalline phase identification method according to this embodiment will be described with reference to FIG. 2.

Like the first or second embodiment, in the first Step 3 (whole pattern fitting step), the information on the crystalline phase selected in Step 2 (search and matching step) is set as the crystalline phase information contained in the sample, and the powder diffraction pattern of the sample is set as the first diffraction pattern. The whole pattern fitting is conducted to calculate the theoretical diffraction pattern of the crystalline phase in the crystalline phase information contained in the sample. Further, like the first or second embodiment, Step 4 (residual information generating step), Step 5 (residual information determining step), and Step 6 (residual information search and matching step) are executed.

In the n-th (n is an integer of n≧1) Step 7 (search and matching result determining step), it is determined whether the further identification is conducted, or not. If the FOM of the crystalline phase newly selected in the n-th Step 6 is equal to or higher than the threshold value, it is determined that the crystalline phase satisfying a given degree of matching cannot be newly identified in Step 6, and the crystalline phase selected in Step 6 is not contained in the sample. Then, the crystalline phase already identified and the content thereof are output to the information output unit 4 as the qualitative analysis result, and the crystalline phase identification method is completed. In this example, the crystalline phase already identified is a total of the crystalline phase selected in Step 2, and the crystalline phase(s) selected in the first to (n−1)-th Steps 6. The crystalline phase already identified in the first (n=1) Step 7 is only the crystalline phase selected in Step 2. Also, the content of the crystalline phase is obtained from the analysis result in the first Step 3 for the crystalline phase selected in Step 2, and obtained from the analysis result in a (k+1)-th Step 3 for the crystalline phase selected in a k-th (k is an integer of 1≦k≦n) Step 6.

On the contrary, in the n-th Step 7, if the FOM of the crystalline phase newly selected in the n-th Step 6 is lower than the threshold value, the crystalline phase in question is newly set as the crystalline phase information contained in the sample, the residual diffraction pattern created in Step 4 is newly set as the first diffraction pattern, and Step 3 is again executed.

In the (n+1)-th Step 3, the first diffraction pattern (the residual diffraction pattern created in the n-th Step 4) is subjected to the whole pattern fitting with the use of the crystalline phase information contained in the sample (the crystalline phase selected in the n-th Step 6) newly generated. Thereafter, in Step 7, it is determined whether the further identification is conducted, or not, through Steps 4, 5, and 6. Steps 3, 4, 5, and 6 are repetitively executed so far as it is determined that the further identification is conducted. As described above, Step 5 is not always necessary.

Also, in the first Step 5, if the residual determination value calculated from the d-I list of the residual diffraction pattern is lower than the set value, the crystalline phase selected in Step 2, and the content of the crystalline phase obtained from the analysis result in the first Step 3 are output to the information output unit 4 as the crystalline phase already identified and the content thereof, and the crystalline phase identification method is completed. In the n-th (n is an integer of n≧2) Step 5, if the residual determination value calculated from the d-I list of the residual diffraction pattern is lower than the set value, the crystalline phase already identified and the content thereof are output to the information output unit 4 as the qualitative analysis result, and the crystalline phase identification method is completed. In this example, the crystalline phase already identified is a total of the crystalline phase selected in Step 2, and the crystalline phases selected in the first to (n−1)-th Steps 6. The content of the crystalline phase is obtained from the analysis result in the first Step 3 for the crystalline phase selected in Step 2, and obtained from the analysis result in a (k+1)-th Step 3 for the crystalline phase selected in a k-th (k is an integer of 1≦k≦n−1) Step 6.

In the crystalline phase identification method according to this embodiment, in Step 6, the first diffraction pattern to be subjected to the whole pattern fitting is the residual diffraction pattern created in one previous round, and the crystalline phase information contained in the sample is information on only the crystalline phase selected in one previous round. As a result, if various kinds of crystalline phases are contained in the sample, even if the number of crystalline phases already identified is already large (n is a large value), the fitting can be conducted at a high speed.

### Other Embodiments

The crystalline phase identification method, the crystalline phase identification device, and the crystalline phase identification program according to the first to third embodiments of the present invention have been described above. In the crystalline phase identification methods according to the first to third embodiments, the threshold value is set for the FOM representing the degree of matching in the search and matching. Also, the set value is set for the residual determination value of the corrected d-I list. As a result, whether the further identification is conducted, or not can be automatically determined, and the crystalline phase identification device 1 according to this embodiment can automatically conduct the qualitative analysis of the sample. In particular, the residual diffraction pattern created in Step 4 (residual information generating step) is refined by the whole pattern fitting, the crystalline phase having smaller content can be identified, and the qualitative analysis can be conducted with higher precision. In order to conduct the qualitative analysis with higher precision with no application of the present invention, a user needs to identify the crystalline phase having the smaller content by taking various measures such as an improvement in the measurement method, an improvement in the sample adjustment, a limit of the retrieval database, and the setting of the search and matching conditions. However, with the application of the present invention, even if the user is low in the level of skill, the automatic qualitative analysis can be conducted with high precision in a short time.

Also, the crystalline phase identification method with higher precision can be realized by setting the threshold value of the FOM and the set value of the residual determination value on the basis of the information on the target sample, which has already been proved, every time the qualitative analysis of the sample is conducted. If elements contained in the target sample have already been proved, or if elements not contained in the target sample have already been proved, the plurality of crystalline phases stored in the database can be restricted or excluded in Step 2 (search and matching step), and Step 6 (residual information search and matching step), and the automatic qualitative analysis can be conducted with higher precision in a shorter period of time.

Further, the crystalline phase identification device 1 according to the first to third embodiments automatically conducts the qualitative analysis of the sample, and the user knows the analysis results displayed on the display unit 12 connected thereto, and studies the reliability of the analysis results. However, during the crystalline phase identification method, the display unit 12 may display the results of the fitting or the search and matching, and the user may obtain a chance for determining the results. For example, in Step 2 or 7, a given number of new candidates of the crystalline phase contained in the sample may be displayed in ascending order of the value of the FOM. The user may select one most reliable candidate from a given number of displayed candidates on the basis of information on the sample which has already been proved. Also, in Step 3, the fitting results may be displayed together with the fitting determination values. The user can study the fitting results, and study the reliability. Further, in Step 5, the residual diffraction pattern or the residual determination value may be displayed. The user study the spectrum of the residual diffraction pattern, and the residual determination value, thereby being capable of determining whether the further identification is conducted, or not. The above crystalline phase identification method can supply the information useful to study the reliability of the qualitative analysis results to the user as needed, and can respond to the needs of the user high in the level of skill.

In the embodiments of the present invention, the measurement data is represented by the x-ray diffraction pattern measured by the x-ray diffraction device. However, the measurement data is not limited to this pattern, but applicable to other diffraction patterns such as neutron rays.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A crystalline phase identification method for identifying crystalline phases contained in a sample by a powder diffraction pattern of the sample with use of a database storing at least information on peak positions and peak intensities of a plurality of crystalline phases, the crystalline phase identification method comprising:
a whole pattern fitting step of subjecting a first diffraction pattern which is the powder diffraction pattern of the sample to whole pattern fitting with use of crystalline phase information contained in the sample which is information on the crystalline phase(s) already identified to calculate a theoretical diffraction pattern of the crystalline phase(s) already identified;
a residual information generating step of generating residual information on the sample on basis of a difference between the theoretical diffraction pattern of the crystalline phase(s) already identified which is calculated in the whole pattern fitting step, and the first diffraction pattern; and
a residual information search and matching step of comparing the residual information generated in the residual information generating step with the peak positions and the peak intensities of the plurality of crystalline phases stored in the database to select a new crystalline phase contained in the sample from the plurality of crystalline phases stored in the database.

2. The crystalline phase identification method according to claim 1, further comprising a search and matching step of, before the whole pattern fitting step, comparing the powder diffraction pattern of the sample with the peak positions and the peak intensities of the plurality of crystalline phases stored in the database to select a crystalline phase contained in the sample from the plurality of crystalline phases stored in the database, and set the selected crystalline phase as the crystalline phase information contained in the sample.

3. The crystalline phase identification method according to claim 1, further comprising a search and matching result determining step of determining whether further identification is conducted, or not, on basis of a matching degree of identification in the residual information search and matching step, and if the further identification is conducted, adding information on the new crystalline phase selected in the residual information search and matching step to the crystalline phase information contained in the sample, and further subjecting the first diffraction pattern which is the powder diffraction pattern of the sample to the whole pattern fitting step, the residual information generating step, and the residual information search and matching step, with use of the crystalline phase information contained in the sample.

4. The crystalline phase identification method according to claim 1, further comprising a search and matching result determining step of determining whether further identification is conducted, or not, on basis of a matching degree of identification in the residual information search and matching step, and if the further identification is conducted, newly setting information on the new crystalline phase selected in the residual information search and matching step as the crystalline phase information contained in the sample, newly setting a residual diffraction pattern obtained by subtracting the theoretical diffraction pattern of the crystalline phase(s) already identified from the first diffraction pattern as the first diffraction pattern, and further subjecting the first diffraction pattern to the whole pattern fitting step, the residual information generating step, and the residual information search and matching step, with the use of the crystalline phase information contained in the sample.

5. A crystalline phase identification device for identifying crystalline phases contained in a sample by a powder diffraction pattern of the sample with use of a database storing information on peak positions and peak intensities of a plurality of crystalline phases, the crystalline phase identification device comprising:
a whole pattern fitting unit that subjects a first diffraction pattern which is the powder diffraction pattern of the sample to whole pattern fitting with use of crystalline phase information contained in the sample which is information on the crystalline phase(s) already identified to calculate a theoretical diffraction pattern of the crystalline phase(s) already identified;
a residual information generating unit that generates residual information on the sample on basis of a difference between the theoretical diffraction pattern of the crystalline phase(s) already identified which is calculated in the whole pattern fitting unit, and the first diffraction pattern; and
a residual information search and matching unit that compares the residual information generated in the residual information generating unit with the peak positions and the peak intensities of the plurality of crystalline phases stored in the database to select a new crystalline phase contained in the sample from the plurality of crystalline phases stored in the database.

6. A non-transitory computer readable medium storing a crystalline phase identification program for identifying crystalline phases contained in a sample by a powder diffraction pattern of the sample with use of a database storing information on peak positions and peak intensities of a plurality of crystalline phases, the crystalline phase identification program causing a computer to function as:
a whole pattern fitting unit that subjects a first diffraction pattern which is the powder diffraction pattern of the sample to whole pattern fitting with use of crystalline phase information contained in the sample which is information on the crystalline phase(s) already identified to calculate a theoretical diffraction pattern of the crystalline phase(s) already identified;
a residual information generating unit that generates residual information on the sample on basis of a difference between the theoretical diffraction pattern of the crystalline phase(s) already identified which is calculated in the whole pattern fitting unit, and the first diffraction pattern; and
a residual information search and matching unit that compares the residual information generated in the residual information generating unit with the peak positions and the peak intensities of the plurality of crystalline phases stored in the database to select a new crystalline phase contained in the sample from the plurality of crystalline phases stored in the database.
